(19) United States
(12) Patent Application Publication
(10) Pub. No.: US 2023/0219330 A1
(43) Pub. Date: Jul. 13, 2023

(54) NEW OR IMPROVED MICROPOROUS MEMBRANES, BUILDING MATERIALS COMPRISING THE SAME, AND METHODS FOR MAKING AND USING THE SAME

(71) Applicant: Daramic, LLC, Charlotte, NC (US)

(72) Inventors: Matthew Stainer, Goleta, CA (US); Eric H. Miller, Philpot, KY (US); Matt J. Wolski, Charlotte, NC (US); Tyler Munhollon, Owensboro, KY (US); Daniel R. Alexander, Matthews, NC (US); Gary L. Fulkerson, Owensboro, KY (US)

(21) Appl. No.: 17/924,076

(22) PCT Filed: May 14, 2021
(86) PCT No.: PCT/US2021/032358

§ 371 Date: Nov. 8, 2022

Related U.S. Application Data
(60) Provisional application No. 63/028,884, filed on May 22, 2020.

(51) Int. Cl. B32B 27/12; B01D 69/02; B01D 71/26; B32B 5/02; B32B 27/20; B32B 27/22; B32B 27/32; B32B 7/12; B32B 7/02; E04B 1/62

(52) U.S. Cl. CPC B32B 27/12; B01D 69/02; B01D 71/261; B32B 5/024; B32B 5/022; B32B 27/20; B32B 27/22; B32B 27/32; B32B 5/028; B32B 7/12; B32B 7/02; E04B 1/625; B01D 2325/38; B01D 2325/20; B01D 2325/04; B32B 2307/73; B32B 2307/7246; B32B 2262/0253; B32B 2419/06; B32B 2307/744; B32B 2307/71

(57) ABSTRACT

In at least one embodiment, a building material comprising a porous membrane having a moderate to high water vapor permeability and high liquid water penetration resistance is disclosed. The building material may be used in building applications, including as or as part of a building wrap, a rain screen, a roofing underlayment, a flashing, a sound proofing material, or an insulation material. The porous membrane may include at least one thermoplastic polymer, at least one filler, and at least one processing oil. The porous membrane may be flat or may have ribs. The porous membrane may include at least one scrim component.

### FIELD

In accordance with at least selected embodiments, this application or invention is directed to new or improved porous membranes and products using the same, and/or methods for making and/or using the same. In accordance with at least certain embodiments, the new porous membranes have high water vapor transmission through the membrane, while simultaneously having high liquid water penetration resistance. These new microporous membranes have many applications, including in the construction industry as a roofing, roofing material, roofing underlayment, roofing component, building wrap, building component, rain screen, flashing, flashing component, sound proofing material, insulation material, flooring, flooring underlayment, flooring component, carpet underlayment, carpet component, and/or the like. The microporous membrane may include at least one scrim component, coating, surface treatment, surface material, ribs, pattern, printing, embossment, adhesive, and/or the like.

### BACKGROUND

Materials having high water vapor transmission through the membrane, while simultaneously having high liquid water penetration resistance, are highly desirable for use in building construction and the like. They provide a physical barrier between the building and the environment. They prevent water from entering the building, while at the same time allowing water vapor to escape. Trapped water vapor, which will likely eventually cool and become liquid water, can lead to issues such as wood rotting or mold. Exemplary uses of these materials include uses in housing wraps, roofing underlayments, building wrap, flashing, rain screens, sound proofing material, insulation material, and/or the like. Known materials include reinforced, non-reinforced, densified or not densified wovens or non-wovens. Coatings and/or surface treatments are typically added to the wovens or non-wovens to improve properties, including liquid water penetration resistance. Standard roofing underlayments are tar paper or asphalt saturated roof felt used between the roof deck and the shingles.

One example of a laminate roofing underlayment 100 is shown in FIG. 1. This material is a laminate material, wherein the very high-strength woven material provides the desired properties of high water vapor transmission through the membrane, while simultaneously having high liquid water penetration resistance. Additional layers are included in the roofing underlayment laminate material shown in FIG. 1 to provide additional desirable properties such as a slip-resistant top layer, which improves the safety of the material when it is being installed on an inclined surface (i.e., a surface other than a horizontal), and a UV and antioxidant protection layer to improve the durability of the film. Additional layers may be added to provide soundproofing, insulation, flame retardance, and/or the like, and combinations thereof. For example, the underlayment 100 in FIG. 1 comprises a slip-resistant top layer 110, a UV& antioxidant protection bond layer 120, a very high-strength woven layer 130, and a reflective barrier 140. As the laminate structure gets more complex, costs goes up, and properties such as water vapor transmission may go down.

Building wrap, such as that used for houses, may have a similar structure to a roofing underlayment, but the same properties are not necessarily required. For example, a building wrap likely does not need to have a liquid water penetration resistance as high as that of a roofing underlayment. One example of a building wrap is available from Benjamin Obdyke, Hydrogap® Drainable Housewrap is shown in FIG. 2 and FIG. 3. This building wrap is a tri-layer drainable building wrap including two non-woven layers surrounding a microporous film to protect it. As shown in FIG. 3, the spacers in this tri-layer building wrap are affixed to, not integral with, tri-layer structure.

Referring now to FIGS. 4 and 5, an exemplary rain screen is the Slicker® rain screen available from Benjamin Obdyke. However due to its open structure, it is not water resistant on its own. As shown in FIG. 5, it must be combined with a water resistive barrier in order to exhibit water resistance.

An exemplary flashing materials may be made of sheet metal, plastic, or a combination of materials, (e.g., metal and plastic), but there are current concerns with trapping water, corrosion and/or UV damage for these materials.

Accordingly, there exists a need for new and improved materials for use in building wraps, rain screens, roofing underlayments, sound proofing materials, flashing, insulation materials, and/or the like. In accordance with the thinking of the present invention or inventors, simplified materials for use in building wraps, rain screens, roofing underlayments, sound proofing materials, flashing, insulation materials, and/or the like are desired, materials that do not need to be combined with other materials to perform the desired functions are preferred, and integral rather than multilayer structures are also preferred.

### SUMMARY

In one aspect, the building material described herein comprises a porous membrane that has a water penetration resistance greater than 400 cm, greater than 500 cm, or greater than 600 cm when measured according to AATCC-127. The porous membrane may comprise a thermoplastic polymer such as a polyolefin, at least one filler, and at least one removable or extractable processing oil, plasticizer, or solvent. In some preferred embodiments, the porous membrane is hydrophobic. In some preferred embodiments, the porous membrane is a microporous membrane. In some preferred embodiments, the porous membrane exhibit a water vapor permeance value from about 5 to about 80 perms, 20 to 80 perms, or 50 to 80 perms when measured according to ASTM E96 (2016), Method B.

In some preferred embodiments, the building material may comprise a reinforced porous membrane. The reinforced porous membrane is formed by providing a reinforcing layer on at least one side of the porous membrane as described hereinabove. The reinforcing layer may be formed from a woven or non-woven material. The woven or non-woven material may be a polyolefin woven or non-woven material. The reinforced porous membrane as described herein has a water penetration resistance greater than 700 cm, greater than 800 cm, greater than 900 cm, or greater than 1,000 cm when measured according to AATCC-127. The drainage efficiency of the building material comprising the reinforced porous membrane is preferably 80% or greater, 85% or greater, 90% or greater, or 95% or greater when measured according to ASTM E2273. In some preferred embodiments, the reinforced porous membrane exhibit a w water vapor permeance value from about 5 to about 80 perms, 20 to 80 perms, or 50 to 80 perms when measured according to ASTM E96 “method B.

In some embodiments, the building material may comprise the porous membrane described herein with a continuous or non-continuous adhesive layer formed thereon. In some embodiments, the porous membrane with the adhesive layer thereon exhibits a water vapor permeance value from about 5 to about 80 perms, 20 to 80 perms, or 50 to 80 perms when measured according to ASTM E96 Method B.

In some embodiments, the building material may comprise a polyolefin porous or microporous membrane as described herein and an entangled mesh attached on one or both sides of the membrane. The entangled mesh may be attached with or without an adhesive. In embodiments where the entangled mesh is attached without an adhesive, it is preferred that the entangled mesh is a polyolefin entangled mesh.

In some embodiments, the building material may comprise an entangled mesh attached to one or both sides of a reinforced porous membrane as described herein. The porous membrane of the reinforced porous membrane may be a polyolefin porous or microporous membrane. The woven or non-woven of the reinforced porous membrane may be a polyolefin woven or non-woven. The entangled mesh may be attached with or without the use of an adhesive. In embodiments where the entangled mesh is attached without an adhesive, it is preferred that the entangled mesh is a polyolefin entangled mesh.

### BRIEF DESCRIPTION OF THE FIGURES

FIG. 1 depicts an existing roofing underlayment article.

FIGS. 2 and 3 depict an existing building wrap article.

FIGS. 4 and 5 illustrate an existing rain screen article.

FIG. 6 is a schematic of an inventive embodiment with ribs.

FIG. 7A and FIG. 7B are schematics of an inventive embodiment with a scrim.

FIG. 8 shows a roofing underlayment system.

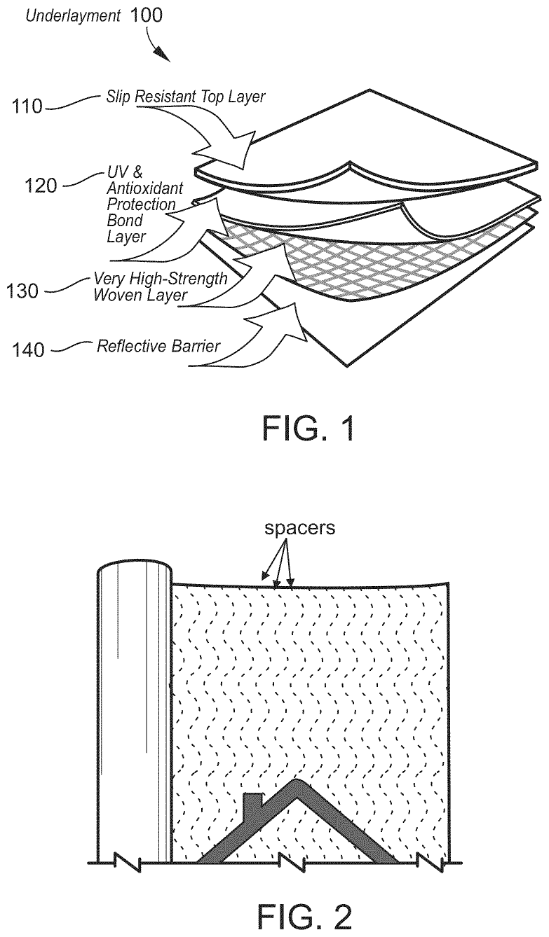

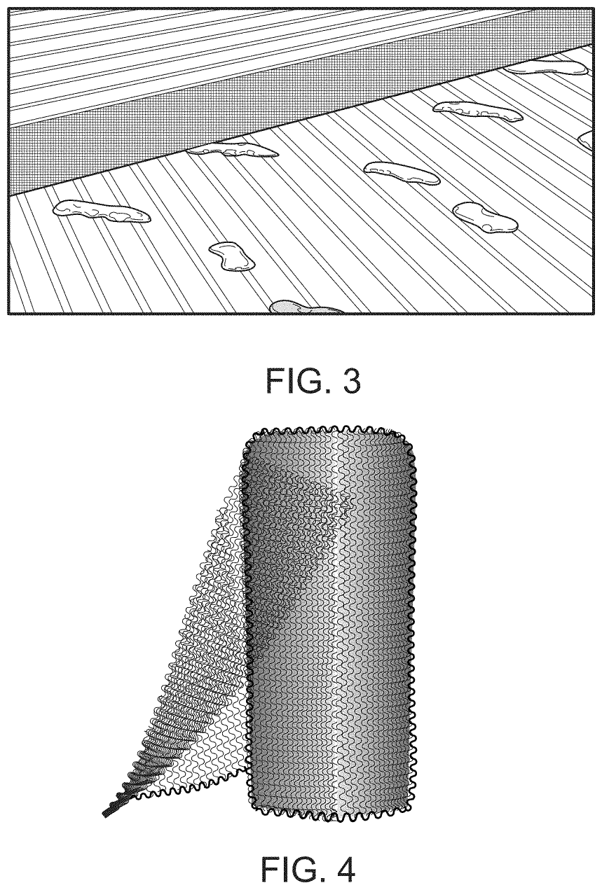

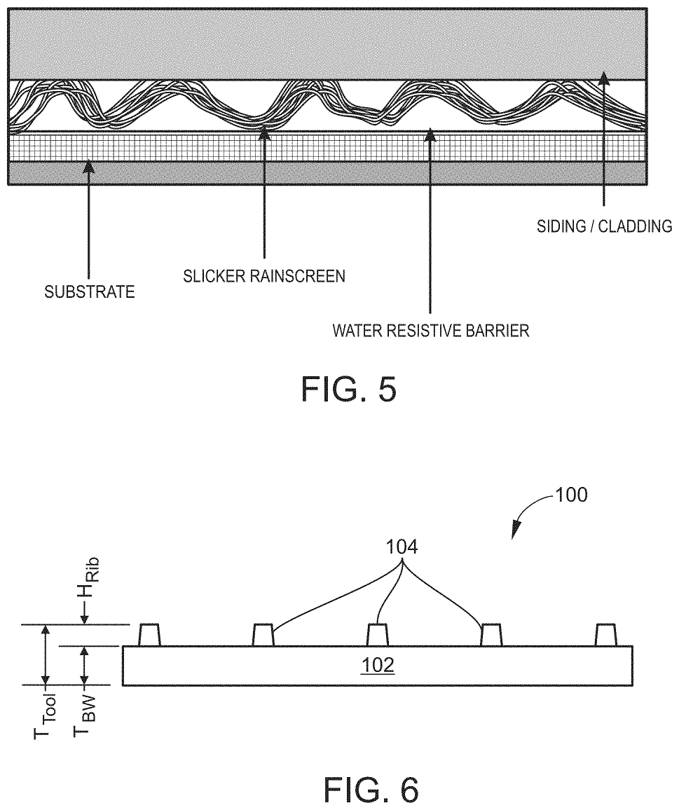

### DETAILED DESCRIPTION

The disclosure of WO 2019/074866, which list Daramic, LLC as the Applicant, is hereby incorporated by reference in its entirety.

In one aspect, a building material comprising, consisting of, or consisting essentially of a porous membrane is described herein.

The porous membrane has a water penetration resistance greater than 400 cm, greater than 425 cm, greater than 450 cm, greater than 475 cm, greater than 500 cm, greater than 525 cm, greater than 550 cm, greater than 575 cm, or greater than 600 cm when measured according to AATCC-127. AATCC 127 Hydrostatic Pressure Test measures the resistance of a fabric to the penetration of water under hydrostatic pressure. Without wishing to be bound by theory, it is believed that the hydrophobicity (lower wettability with water) of the microporous membrane surface is at least partially responsible for its high liquid water resistance. Measurements up to 1,000 cm or more may be achieved if a supporting grid or mesh is used when testing the membrane. This way, true water resistance can be measured without being limited by the mechanical strength of the film, which may burst without a supporting grid or mesh before the true water resistance value is measured.

In some preferred embodiments, the porous membrane exhibit a water vapor permeance value from 5 to about 80 perms, 10 to 80 perms, 15 to 80 perms, 20 to 80 perms, 25 to 80 perms, 30 to 80 perms, 35 to 80 perms, 40 to 80 perms, 45 to 80 perms, 50 to 80 perms, 55 to 80 perms, 60 to 80 perms, 65 to 80 perms, 70 to 80 perms, or 75 to 80 perms when measured according to ASTM E96 method.” Water vapor permeability of the microporous membrane described herein may be quantified by calculating the moisture vapor permeance of the film. The moisture vapor permeance is calculated according ASTM standard E96 “method,” and the unit for moisture vapor permanence is “perms.” High water vapor permeance corresponds to high water vapor permeability

Thus, the porous membrane described herein is both inpenetrable to water and breathable, making it useful in many applications, including in the construction industry as a roofing, roofing material, roofing underlayment, building wrap, rain screen, flashing, sound proofing material, insulation material, and/or the like

Porous Membrane

The porous membrane is not so limited and may be microporous, macroporous, or nanoporous. Methods for making the porous membrane are described in WO 2019/074866, which list Daramic LLC as the Applicant, is hereby incorporated by reference in its entirety.

Structure

In some preferred embodiments, the porous membrane may be a microporous membrane. A microporous membrane as described herein is one having pores where the average pore size is preferably between 0.1 and 5.0 microns, between 0.1 and 4.0 microns, between 0.1 and 3.0 microns, between 0.1 and 2.0 microns, or between 0.1 and 1.0 microns. In some embodiments, the pores are between 0.1 and 0.9 microns, between 0.1 and 0.8 microns, between 0.1 and 0.7 microns, between 0.1 and 0.6 microns, between 0.1 and 0.5 microns, between 0.1 and 0.4 microns, between 0.1 and 0.3 microns, or between 0.1 and 0.2 microns.

With reference now to FIG. 6, an exemplary inventive microporous membrane 100 is schematically shown having a backweb 102 and optional ribs 104. The membrane has an associated backweb thickness T_{BW}, rib height H_{Rib}, and total thickness T_{Total}. In some embodiments, the microporous film is a single layer, bi-layer, or multilayer structure. In preferred embodiments, it is a single layer extruded or co-extruded layer.

Select embodiments of the microporous membrane 100 may be flat or have optional ribs 104 on one or both sides or surfaces thereof. In one exemplary embodiment, the microporous membrane 100 has a flat backweb 102 with ribs 104 on one surface (as shown) or ribs on both surfaces of the flat backweb (not shown).

In certain exemplary embodiments, the microporous membrane 10 may be provided with any one of the following: solid ribs, discrete broken ribs, continuous ribs, discontinuous ribs, angled ribs, linear ribs, longitudinal ribs extending substantially in a machine direction of said porous membrane, lateral ribs extending substantially in a cross-machine direction of said porous membrane, transverse ribs extending substantially in said cross-machine direction of the separator, cross mini-ribs, serrations or serrated ribs, battlements or battlemented ribs, curved or sinusoidal ribs, disposed in a solid or broken zig-zag-like fashion, grooves, channels, textured areas, embossments, dimples, nubs, porous, non-porous, mini ribs, cross-mini ribs, and combinations thereof.

With continued reference to FIG. 6, the ribs 104 may be formed by a variety of methods, including by extrusion, co-extrusion, embossing (done, for example, at room temperature to about 50° C.), printing (screen-printing, intaglio-printing, etc.), patterning (etching for example), calendering (done, for example, at temperatures between about 100° C. to about 250° C.). The ribs 104 may be linear or non-linear ribs as shown in FIG. 4. The ribs 104 may have a height T_{Rib} of from approximately 0.1 mm to approximately 12 mm, measured from the surface of the microporous membrane backweb 102 to the tip of the ribs 104. The ribs may be integral (like those formed by extrusion, co-extrusion, embossing, calendering, or etching) or non-integral (like those formed by printing).

The backweb thickness T_{BW} of the microporous membrane 100 is not so limited and may be, for example, from approximately 50 μm to approximately 500 mm, from approximately 75 μm to approximately 300 mm, from approximately 100 μm to approximately 100 mm, from approximately 125 μm to approximately 50 mm, from approximately 150 μm to approximately 25 mm, from approximately 500 μm to approximately 10 mm, from approximately 50 μm to approximately 1.0 mm, from approximately 50 μm to approximately 850 μm, from approximately 50 μm to approximately 650 μm, from approximately 50 μm to approximately 450 μm, from approximately 50 μm to approximately 250 μm, or from approximately 50 μm to approximately 100 μm. Calendering the porous membrane may also impart integral features into the material, set the product height, and/or the like.

Composition

The possibly preferred porous or microporous membrane described herein may be or contain at least one of a thermoplastic polymer, at least one filler, at least one processing oil, and optionally, one or more additional components to provide different properties such as flame retardance. These components are described in further detail herein and herein below.

The at least one thermoplastic polymer is not so limited and may be a variety of thermoplastic polymers not inconsistent with the stated goals herein. For example, the thermoplastic polymer may be or contain an acid resistant thermoplastic polymer or a thermoplastic polymer that is not acid resistant. Some preferred thermoplastic polymers are polyvinyl chloride, a phenolic resin, polyethylene and polypropylene, polyethylene of high molecular weight (e.g., high or ultrahigh molecular weight polyethylene), polyethylene of low molecular weight (e.g., low or ultralow molecular weight polyethylene), or mixtures thereof. In some embodiments, a high or ultrahigh molecular weight polyethylene (HMWPE or UHMWPE) alone, or mixtures of HMWPE and/or UHMWPE with low molecular weight polyethylene (LMWPE) or an ultralow molecular weight polyethylene (ULMWPE) are particularly preferred for use as the thermoplastic polymer, or another molecular weight polyethylene may be used.

High molecular weight polyethylene (HMWPE) is a polyethylene polymer having a weight average molecular weight of from least approximately 1×10⁵ to less than approximately 1×10⁶. Ultrahigh molecular weight polyethylene (UHMWPE) is a polyethylene polymer having a weight average molecular weight of approximately 1×10⁶ or greater, preferably in some embodiments, between approximately 1×10⁶ and approximately 15×10⁶, between approximately 3×10⁶ and approximately 10×10⁶, or between approximately 5×10⁶ and approximately 9×10⁶. The content of the HMWPE and/or UHMWPE is approximately 1 wt. % or more, preferably in some embodiments between approximately 10 wt. % to approximately 90 wt. % based on the total weight of the thermoplastic polymer, and preferably in other embodiments between approximately 10 wt. % to approximately 70 wt. %.

In embodiments where a low molecular weight polyethylene and/or an ultra-low molecular weight polyethylene are used, the amount of the low or ultra-low molecular weight polyethylene can be present in an amount from approximately 0.1 wt. % to approximately 20 wt. %, from approximately 0.5 wt. % to approximately 15 wt. %, from approximately 1.0 wt. % to approximately 10 wt. %, or from approximately 1.0 wt. % to approximately 5 wt. % based on the total weight of the at least one thermoplastic resin. Low molecular weight polyethylene has a weight average molecular weight ranging from of approximately 100 k to approximately 150 k (e.g., approximately 100 k to approximately 125 k). An ultra-low molecular weight polyolefin may have a molecular weight less than approximately 100 k.

In some embodiments, the thermoplastic polymer may be recycled to improve environmental friendliness of the product. The amount of recycled material used may be adjusted so as to not be a detriment the performance of the product.

In some embodiments, the membrane and the scrim may be the same thermoplastic polymer (such as both being PE or PP) and may be recycled together to improve environmental friendliness of the product.

In some embodiments, the membrane and the scrim may both be polyolefins and may be the same or different thermoplastic polymer (such as both being PE or PP, or one being PE and the other being PP) and may be recycled separately or together to improve environmental friendliness of the product. A PE membrane and a PP scrim is just one example.

The filler of the microporous membrane is not so limited, and may be a variety of inorganic or organic filler not inconsistent with the state goals herein, which include reducing costs while still providing a microporous membrane having the properties described herein. The inorganic and/or organic filler may include spherical or irregular particles, flakes, pellets, or agglomerates of material. The amount of filler in the microporous membrane may be from about 5 wt. % to about 65 wt. %, from about 5 wt. % to about 60 wt. %, from about 10 wt. % to about 50 wt. %, from about 15 wt. % to about 40 wt. %, from about 20 wt. % to about 30 wt. %, or from about 25 wt. % to about 30 wt. % based on the total weight of the membrane.

In some preferred embodiments, the filler may be or contain at least one inorganic or organic filler made of or containing a material that is more hydrophobic or has a lower surface wettability with water (when uncoated and untreated) than silica does (when uncoated or untreated). And in some preferred embodiments, the at least one inorganic or organic filler has a lower surface wettability with water (when uncoated and untreated) than polyethylene does (when uncoated or untreated). In some preferred embodiments, the filler may be or contain at least one inorganic or organic filler made of or containing a material that has a low surface wettability with water, i.e., has exhibits a contact angle greater than or equal to about 90°, greater than about 90°, greater than about 100°, greater than about 120°, greater than about 130°, greater than about 140°, greater than about 150°, greater than about 160°, or greater than about 170°, but in all cases less than about 180°. The surface wettability with water (i.e., contact angle) may be measured according to ASTM D7334-08(2013) or equivalents. In some embodiments, the at least one organic or inorganic filler is non-wetting. The organic or inorganic filler may or may not be subjected to a surface treatment or surface coating to obtain the desired wettability or hydrophobicity.

Non-limiting examples of materials that can be used as the filler include the following: carbon black, talc, calcium carbonate, kaolin, diatomaceous earth, clay, wollastonite, mica, aluminum oxide (Al₂O₃), boehmite (Al(O)OH), zirconium dioxide (ZrO₂), titanium dioxide (TiO₂), barium sulfate (BaSO₄), barium titanium oxide (BaTiO₃), aluminum nitride, silicon nitride, calcium fluoride, barium fluoride, zeolite, apatite, mullite, spinel, olivine, mica, tin dioxide (SnO₂), indium tin oxide, oxides of transition metals, and mixtures thereof.

In some embodiments, silica can be included as one of the fillers. In some preferred embodiments, when silica is included as one of the at least one inorganic filler and organic filler, it may be included in addition to at least one of the following: carbon black, talc, calcium carbonate, kaolin, diatomaceous earth, clay, wollastonite, mica, aluminum oxide (Al₂O₃), boehmite (Al(O)OH), zirconium dioxide (ZrO₂), titanium dioxide (TiO₂), barium sulfate (BaSO₄), barium titanium oxide (BaTiO₃), aluminum nitride, silicon nitride, calcium fluoride, barium fluoride, zeolite, apatite, mullite, spinel, olivine, mica, tin dioxide (SnO₂), indium tin oxide, oxides of transition metals, and mixtures thereof. In some preferred embodiments, silica (or some equally hydrophilic filler, (e.g., a filler with a contact angle of about 96° or more when uncoated and untreated)) is added as one of the fillers in addition to one or more other inorganic or organic fillers that are more hydrophobic or have a lower surface wettability with water than silica (or the alternative). The additional one or more inorganic filler or organic filler may be subjected to a surface treatment or coating to increase its hydrophobicity or decrease its surface wettability. In this case, the additional one or more surface treated or coated inorganic or organic filler should be more hydrophobic or have a lower surface wettability with water than silica. In some embodiments, the at additional one or more inorganic filler or organic filler (with or without being surface treated or coated) has a surface wettability with water such that the wetting angle is 90° or more, 100° or more, 120° or more, 130° or more, 140° or more, 150° or more, 160° or more, or 170° or more. In some embodiments, the additional one or more inorganic filler or organic filler is non-wettable or has a wetting angle of 180°.

In some preferred embodiments, the at least one organic or inorganic filler that is more hydrophobic, or has a lower surface wettability with water than silica, is present in an amount of from approximately 5 wt. % to approximately 30 wt. % (but may be present up to 60 wt. %) with respect to the total weight of the microporous membrane. In some embodiments, the at least one organic or inorganic filler that is more hydrophobic or has a lower surface wettability with water than silica is carbon black.

The processing oil (or plasticizer) is not so limited. Without wishing to be bound by theory, it is believed that the processing oil improves the manufacturing processability of the thermoplastic polymer (e.g., UHMWPE), and is used to create, at least in part, the microporous structure of the membrane when it is removed or extracted during the manufacturing process. The processing oil, in some embodiments, has little solvating effect on the thermoplastic polymer at 60° C., only a moderate solvating effect at elevated temperatures on the order of about 100° C., and a significant solvating effect at elevated temperatures on the order of about 200° C. Suitable processing oils are, in some embodiments, a liquid at room temperature and include those meeting the requirements of ASTM D 2226-82, Types 103 and 104 or equivalents. Preferred in some embodiments are those oils which have a pour point of less than 22° C. according to ASTM D 97-66 (reapproved 1978) or equivalents. Particularly preferred are oils having a pour point of less than 10° C. In some preferred embodiments, the processing oil may be, for example, any one of the following: mineral oil, olefinic oil, paraffinic oil, naphthenic oil, aromatic oil, or mixtures thereof. Also see U.S. Pat. Nos. 3,351,495 and 4,861,644, incorporated herein by reference, for additional processing oil (or plasticizer) suggestions.

In some embodiments, the amount of processing oil in the microporous membrane is, for example, from about 0.1 wt. % to about 40 wt. %, from about 0.1 wt. % to about 35 wt. %, from about 0.1 wt. % to about 20 wt. %, from about 1 wt. % to about 10 wt. %, or from about 1 wt. % to about 5 wt. % with respect to the weight of the microporous membrane. In some preferred embodiments, the amount of processing oil is as close to zero as possible because the presence of processing oil may increase flammability. However, due to costs restraints, sometimes processing oil remains in the amounts disclosed herein, and flammability issues may be addressed by the addition of flame retardants as part of the microporous membrane itself or as part of a coating applied to one or more sides of the microporous membrane.

One or more additional components may be added and are not so limited. They may include a variety of additional components that impart desirable properties to the microporous film. Examples of desirable properties include: flame retardance, reflectivity, friction, UV resistance, etc. A flame retardant may be added for flame retardance and the flame retardant may be a halogenated or non-halogenated flame retardant. Preferred flame retardants are any that are stable above 180° C. A UV absorbent may be added for UV resistance, including benzotriazoles, benzophenones, carbon black, and titanium dioxide. Metal particles may be added for increased reflectivity. Adding additional fillers may increase surface friction of the microporous membrane. At least certain flashing embodiments may include colorants and may be provided in several colors (such as gray, black, brown, or white [may add TiO2]), may have a metal look or metal coating, and/or may be paintable on at least one side and/or edge.

In some embodiments, one or more additional components may be added to the microporous membrane itself for a particular purpose, and in addition to this, a coating or treatment may be provide on one or more surfaces of the microporous membrane to achieve this purpose. For example a flame retardant may be included as part of the microporous membrane and/or may be applied to one or more surfaces of the microporous membrane as a coating.

The amount of the one or more additional components is not so limited and may be present in a variety of ranges from about 0.1 wt. % to about 70 wt. %, from about 0.1 wt. % to about 60 wt. %, from about 0.1 wt. % to about 50 wt. %, from about 0.1 wt. % to about 40 wt. %, from about 0.1 wt. % to about 30 wt. %, from about 0.1 wt. % to about 20 wt. %, from about 0.1 wt. % to about 15 wt. %, from about 0.5 wt. % to about 10 wt. %, or about 1.0 wt. % to about 5.0 wt. % based on the total weight of the microporous membrane.

In some embodiments, the microporous membrane may be subjected to one or more surface treatments or have one or more coatings provided thereon.

In some preferred embodiments, a flame or fire retardant may be added to the microporous membrane itself.

In some preferred embodiments, a coating may be provided to impart flame retardance to the microporous membrane may be applied to the microporous membrane in addition to or instead of adding a flame or fire retardant compound to the microporous membrane itself. For example, a coating may be a flame retardant applied to one or more surfaces of the microporous membrane. The flame retardant may be, for example, magnesium hydroxide, mono and diammonium phosphate, ammonium bromide, ammonium chloride, boric acid, borax, ammonium borate, ethanolammonium borate, phosphate or sulfamate, ammonium sulfamate, organic phosphate esters, or halogenated organic compounds like decabromodiphenyl oxide, chlorinated or brominated paraffin, chlorinated or brominated binders, thiourea, hydrated alumina, graphite, antimony oxides, and/or the like, and combinations thereof. Application methods include those known in the art, such as padding, gravure coating, foam coating, slot coating, printing, spraying, paste coating, powder application, kiss coating, and screen coating. The flame retardant may be added to the coating composition alone, or in combination with other components such as lubricants, binders, antimicrobials, color, water and oil repellents, surfactants, and other chemical auxiliaries known to the art. Following the application, the coating may be dried.

In some preferred embodiments, the microporous membrane with or without the flame retardant coating may be class A fire rated, having passed the ASTM E-84 requirements or equivalents.

Porous Membrane+Reinforcing Layer

In some embodiments, the building material described herein may comprise, consist of, or consist essentially of a porous membrane as described herein and a reinforcing layer on at least one side of the porous membrane. The result is a reinforced porous membrane. In some embodiments, the reinforcing layer may be provided on both sides of the porous membrane. Preferably, the reinforcing layer is formed directly on at least one surface of the porous membrane. In some embodiments, the reinforcing layer is formed directly on both surfaces of the porous membrane.

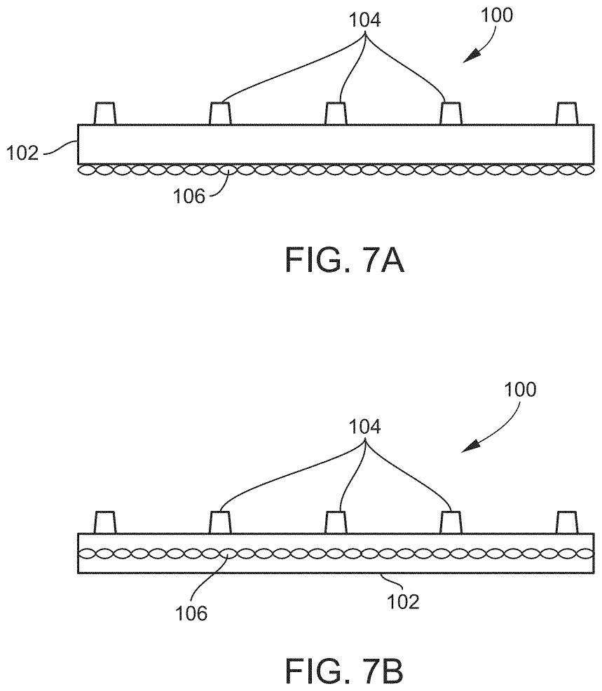

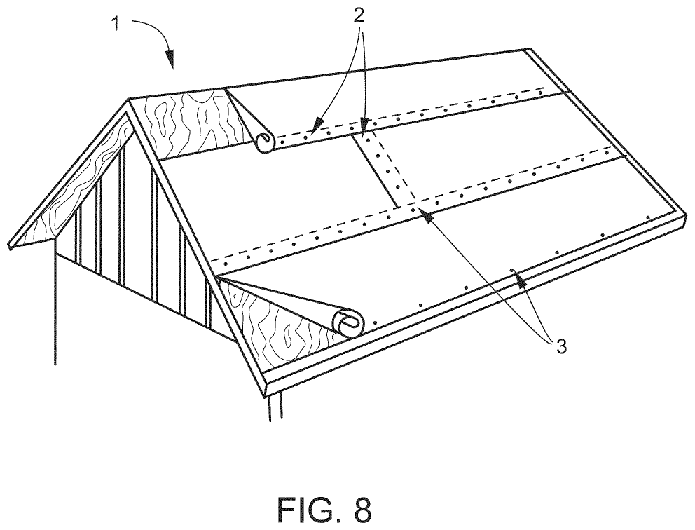

With reference to FIGS. 6, 7A, and 7B, certain select embodiments 100 may be provided as a multilayer structure having a scrim or scrim material component or layer is provided as the reinforcing layer 106. As used herein, “scrim” may be defined by its known definition or as a fibrous mat or material, a reinforcing layer or material, and/or the like, and/or combinations thereof. The scrim or scrim material of the reinforcing layer 106 may be added to the porous membrane 102 in order to improve the mechanical properties and characteristics, such as the tensile strength, tear strength, shear strength, and/or the like, and/or combinations thereof.

Certain embodiments may provide the scrim reinforcing layer 106 as a glass mat, polyester fleece, polymer mesh or netting, and/or the like, and combinations thereof. Such examples of scrim material may be a cross laminated polyolefin open mesh nonwoven or co-extruded cross laminated strands. Additional exemplary embodiments of the scrim or scrim material may further include heat bondable extruded netting and heat bondable spun bond or meltblown (or composite spunbond-meltblown-spunbond (“SMS”)) nonwoven material.

With reference to the multilayer structure 100 in FIG. 7A, the scrim reinforcing layer 106 may be added to the porous membrane 102 as a layer via heat bonding during any feasible step in the manufacturing process. One such method may heat bond the scrim 106 to the porous membrane after extruding the processing oil (extraction of the processing oil is described hereinafter). As shown in FIG. 7A, the scrim may be bonded to a side opposite the ribs 104 or bonded to the side having ribs 104 thereon. With reference to FIG. 7B, another exemplary method may provide the scrim 106 by incorporating it in the porous membrane 102 during the extrusion process (the extrusion process is described hereinafter). In some embodiments of the multilayer structure 100 as shown in FIG. 7B, the scrim 106 may be incorporated approximately in the middle of the porous membrane 102. In other embodiments, the scrim may be incorporated closer to the side of the porous membrane having ribs 104 or incorporated closer to the side opposite to the side of the porous membrane having ribs. Calendering the porous membrane and scrim assembly may also impart integral features into the material, set the product height, and/or the like.

In some embodiments, the reinforcing layer may comprise, consist of, or consist essentially of a woven or a non-woven material. For example, in some preferred embodiments, the reinforcing layer may comprise, consist of, or consist essentially of a scrim. The woven or non-woven material may be a polymeric or metallic woven or non-woven material. In some preferred embodiments, the woven or non-woven material may be a polyolefinic woven or non-woven material. For example, the polyolefin may be, in some preferred embodiments, a polyethylene, a polypropylene, or blends or co-polymers thereof.

In some embodiments, the reinforcing layer is attached to the porous membrane with or without an adhesive. For example, the reinforcing layer may be thermally bonded to the porous membrane. Thermal bonding is particularly useful when both the porous membrane and the reinforcing layer have similar softening points. This way, bonding can occur without deforming a portion having a lower melting point. For example, in some preferred embodiments, the porous membrane and the reinforcing layer may be polyolefinic.

Attaching a reinforcing layer to the porous membrane improves many properties compared to the porous membrane alone. For example, the strength of the reinforced porous membrane is greater than that of the porous membrane itself. Additionally, the measured water penetration resistance of the reinforced porous membrane is increased compared to the porous membrane alone. Without wishing to be bound by any particular theory, it is believed that while the scrim itself does not increase water resistance due to its open nature, it increases the mechanical strength of the sample, resulting in higher measured water resistance values more likely to be the true water resistance values of the sample. This is due to the fact that the reinforced samples do not break as easily when tested. For example, the reinforced porous membrane may have a measured water penetration resistance greater than 700 cm, greater than 750 cm, greater than 800 cm, greater than 850 cm, greater than 900 cm, greater than 950 cm, greater than 1,000 cm, or greater than 1050 cm when measured according to AATCC-127. The drainage efficiency of the reinforced porous membrane is preferably 80% or greater, 81% or greater, 82% or greater, 83% or greater, 84% or greater, 85% or greater, 86% or greater, 87% or greater, 88% or greater, 89% or greater, 90% or greater, 91% or greater, 92% or greater, 93% or greater, 94% or greater, 95% or greater, 96% or greater, 97% or greater, 98% or greater, 99% or greater, or 100% when measured according to ASTM E2273. In some preferred embodiments, the reinforced porous membrane exhibits a water vapor permeance value from about 5 to about 80 perms, 10 to 80 perms, 15 to 80 perms, 20 to 80 perms, 25 to 80 perms, 30 to 80 perms, 35 to 80 perms, 40 to 80 perms, 45 to 80 perms, 50 to 80 perms, 55 to 80 perms, 60 to 80 perms, 65 to 80 perms, 70 to 80 perms, or 75 to 80 perms when measured according to ASTM E96 Method B.

The reinforced porous membrane is useful in many applications, including in the construction industry as a roofing, roofing material, roofing underlayment, building wrap, rain screen, flashing, sound proofing material, insulation material, and/or the like.

Porous Membrane+Adhesive or Reinforced Porous Membrane+Adhesive

In some embodiments, the building materials described herein may comprise, consist of, or consist essentially of an adhesive layer on at least one surface of the porous membranes or the reinforced porous membranes described therein. The result is building material comprising an adhesive porous membrane or adhesive reinforced porous membrane that can be applied to a building without the use of nails or other attachment means that may make holes in the materials. Nail holes become points of entry for water, so eliminating nail holes reduces the number of entry points for water.

The adhesive layer may be applied continuously or non-continuously on at least one of a surface of the porous membrane, a surface of the porous membrane of a reinforced porous membrane, and a surface of the reinforcing layer in a reinforced porous membrane.

In some preferred embodiments, the adhesive may cover less than 100% of the surface area on one surface of the porous membrane. Preferably, the adhesive may cover less than 90%, less than 80%, less than 70%, less than 60%, less than 50%, less than 40%, less than 30%, less than 20% or less than 10% of the surface area on one area of the porous membrane. The more surface area covered by the adhesive, particularly if the adhesive is not breathable, the less breathable the resulting building material becomes. However, enough adhesive should be applied so that the resulting building material has good adhesion when applied to a surface.

The adhesive used is not so limited, but in some embodiments, the adhesive may be a hot melt adhesive, a pressure sensitive adhesive, an epoxy adhesive, an acrylic adhesive, a spray adhesive, and a resin adhesive. In some embodiments, the adhesive may be breathable. With a breathable adhesive, breathability of the porous membrane is maintained even when a large surface area is covered with adhesive. For example, if the adhesive covers more than 80% of the surface are of the porous membrane and water vapor permeanance does not decrease more than 10% from that of the porous membrane without any adhesive, then the adhesive could be considered breathable.

One measure of breathability is water vapor permeance. In some preferred embodiments, the adhesive porous membrane or the adhesive reinforced porous membrane exhibits a water vapor permeance value from about 5 to about 80 perms, 10 to 80 perms, 15 to 80 perms, 20 to 80 perms, 25 to 80 perms, 30 to 80 perms, 35 to 80 perms, 40 to 80 perms, 45 to 80 perms, 50 to 80 perms, 55 to 80 perms, 60 to 80 perms, 65 to 80 perms, 70 to 80 perms, or 75 to 80 perms when measured according to ASTM E96 Method B.

In some embodiments, a peelable or release liner may be provided on top of the adhesive layer to protect the adhesive layer and maintain its adhesive properties. The liner may be removed before using the adhesive layer. For example, the liner may be removed before providing the adhesive porous membrane onto a roof or the like.

### Porous Membrane+Entangled Mesh

In some embodiments, a building material may comprise the porous membrane or reinforced porous membrane as described herein and an entangled mesh provided on at least one side thereof.

In some embodiments, an entangled mesh may be provided on both sides of the porous membrane. The mesh may be provided directly on a surface of the porous membrane, or there may be an intervening layer between a surface of the porous membrane and the mesh. The mesh may be provided with or without use of an adhesive. For example, one way of bonding without an adhesive may include thermal bonding or melt bonding.

In embodiments where the mesh is provided on a reinforced porous membrane as described herein, the mesh may be provide directly or indirectly (intervening layer) on the reinforcing layer, on the porous membrane, or on both the porous membrane and the reinforcing layer. The mesh may be provided with or without use of an adhesive.

In further building material embodiments including an entangled mesh, an adhesive layer may be formed on the porous membrane, on the entangled mesh, or on the reinforcing layer to make the building material adhesive. The adhesive may be as described herein above in the section entitled “Porous Membrane+Adhesive or Reinforced Porous Membrane+Adhesive.”

The entangled mesh described herein is not so limited. There are commercially available entangled mesh and products that may be made to order.

In some preferred embodiments, the entangled mesh is a polyolefinic entangled mesh and the porous membrane is polyolefinic. For example, polyolefinic may mean that the mesh is made of a polyolefin homopolymer, polyolefin copolymer, or polyolefin blend. For example, in some preferred embodiments, the polyolefin may be a homopolymer, copolymer, or blend of polyethylene, polypropylene, or combinations thereof. In some embodiments, the entangled mesh is a polyolefinic entangled mesh, the porous membrane is a polyolefinic porous membrane, and the reinforcing layer is a polyolefinic reinforcing layer. For example, polyolefinic may mean that the mesh is made of a polyolefin homopolymer, polyolefin copolymer, or polyolefin blend. For example, in some preferred embodiments, the polyolefin may be a homopolymer, copolymer, or blend of polyethylene, polypropylene, or combinations thereof.

Methods for making and using the products disclosed herein are not so limited. Some may be disclosed in WO/2019/074866 to Daramic, LLC, which is incorporated by reference herein in its entirety.

Applications for Building Materials

Any inventive building material described herein can be incorporated into any product for any application where the building material might be useful. Building materials described herein would be particularly useful for products and/or applications where passage of water vapor across the membrane is desirable, but passage of liquid water is not. A few applications envisioned by the inventors of this application include the following: use in roofing underlayment, use in drainable and non-drainable building wrap, use in flashing, use in rain screens, use in insulation material, and use in sound proofing material.

When used in or as a roofing underlayment, the roofing underlayment may include any building material described herein.

A roofing underlayment system is not so limited and may essentially be any roofing underlayment as generally described herein attached or mounted to a roof deck. The roof deck may be made of any material, including plywood, particle board, brick, stone, plastic, or other materials. The roofing underlayment may be attached or mounted to the roof deck using any means, including adhesives, and/or mechanical fasteners (e.g., nails, screws, staples, etc.). FIG. 8 shows an exemplary roofing underlayment system including a roof deck 1, a roofing underlayment 2, and a fastening or attachment means 3. In some embodiments, the fastening or attaching means may be an adhesive and in some embodiments they may be nails.

When used in or as a building wrap, the building wrap may include essentially any building material as generally described herein.

A building wrap system is not so limited and may include any building wrap as generally described herein attached or mounted to exterior wall sheathing. In some preferred embodiments, the exterior wall sheathing may be made of stone, brick, plastic, plywood, or wood. The building wrap may be attached or mounted to the wall sheathing by a variety of means such as with adhesives, and/or mechanical fasteners (e.g., nails, screws, staples, etc.). In some embodiments, the building wrap itself, i.e., without the addition of an adhesive to one or more surfaces thereof, may be adhered to an exterior wall sheathing made of stone, brick, plastic, plywood, etc. For example, the building wrap may be tacky such that when pressure is applied thereto it may be attached to an exterior wall sheathing.

When used in an insulating material, the insulating material may include essentially any building material as generally described herein. An insulating system may include insulating material disposed between at least two wall studs, rafters, or joists of a building, or any other building cavity.

When used as a sound-proofing material, the sound-proofing material may include essentially any building material as generally described herein. The sound proofing material may be self-adhesive or non-self-adhesive. A sound proofing system may include a laminate wall or floor, wherein the laminate includes the sound proofing material. In some embodiments, at least one layer of a laminate floor or wall includes a building material as generally described herein as a sound proofing material.

When used as a rain screen, the rain screen may include essentially any building material described herein, and particularly examples where the porous membrane may include positive ribs having a rib height from the surface of the microporous membrane to the tip of the rib of at least about 12 mm, at least about 10 mm, at least about 9 mm, at least about 8 mm, at least about 7 mm, at least 6 mm, at least 5 mm, at least 4 mm, at least 3 mm, at least 2 mm, at least 1 mm, at least 0.5 mm, or at least 0.1 mm. In preferred embodiments, the rain screen may include essentially any microporous membrane described herein with the appropriate rib height. The rain screen may be a self-adhesive or non-self-adhesive rain screen. When used in a rain screen system, the rain screen may be attached or mounted to an exterior wall sheathing, and in some embodiments, wood or vinyl siding, brick, stone, or logs touching the ribs of the rain screen. In some embodiments, the rain screen is attached or mounted to the sheathing with adhesives, and/or mechanical fasteners (e.g., nails, screws, staples, etc.). The rain screen itself, i.e., without the addition of an adhesive to any surfaces thereof, may be self-adhesive and attached to exterior wall sheathing, and in some embodiments, wood or vinyl siding, brick, stone, or logs. For example, the rain screen itself may be tacky in some embodiments, such that if pressure is applied the rain screen becomes attached to exterior wall sheathing, and in some embodiments, wood or vinyl siding, brick, stone, or logs.

In an exemplary preferred embodiment, the rain screen will include building material as described herein (with or without an adhesive to make it self-adhesive). The rain screen will not need to be used in combination with a water resistive barrier because it will, itself, provide excellent water resistance.

When used as a flashing or weatherproofing, the flashing may include any building material as generally described herein.

A flashing or weatherproofing system is not so limited and may include any flashing as generally described herein. The flashing may be attached to or mounted on any variety of roofing or building joints, such as at chimneys, vent pipes, walls, windows and door openings. The flashing may be attached or mounted to the joints by such means as adhesives, and/or mechanical fasteners (e.g., nails, screws, staples, etc.). The flashing itself, i.e., without the addition of an adhesive, may, in some be adhered to any variety of roofing or building joints, such as at chimneys, vent pipes, walls, windows and door openings. For example, the flashing itself may be tacky in some embodiments, such that if pressure is applied the membrane may be adhered to a surface of any variety of roofing or building joints, such as at chimneys, vent pipes, walls, windows and door openings.

### Examples

Five exemplary building material embodiments with microporous membranes including at least one thermoplastic polymer, at least one filler, and at least one processing oil were prepared.

Embodiment 1 was made using SiO2, ultra-high molecular weight polyethylene (UHMWPE), carbon black, and low density polyethylene (LDPE). This membrane was not stretched.

Embodiment 2 was made using SiO2, ultra-high molecular weight polyethylene (UHMWPE), carbon black, and low density polyethylene (LDPE) in the same amounts as Embodiment 1. Unlike Embodiment 1, Embodiment 2 was 7×TD stretched.

Embodiment 3 was made using SiO2, ultra-high molecular weight polyethylene (UHMWPE), carbon black, and low-density polyethylene (LDPE) in the same amounts as Embodiment 1 and Embodiment 2. Like Embodiment 2, Embodiment 3 was also 7×TD stretched. Embodiment 3 also comprised a scrim attached to the microporous membrane.

Embodiment 4, was made with Mg(OH)2 as a flame retardant, ultra-high molecular weight polyethylene (UHMWPE), carbon black, and low density polyethylene (LDPE). This membrane was not stretched.

Embodiment 5, has the same make-up as Embodiment 4 except that it was 5×TD stretched and 3×MD stretched.

Some properties of these embodiments are included in Table 1, below:

TABLE 1

| | | | | | Water |
|---|---|---|---|---|---|
| | | | WVTR | | Resistance |
| embodi- | thickness | basis | (g/m2/ | Permeance | AATCC 127 |
| ment | (mm) | weight(g/m2) | 24 hr) | (perm) | (cm H2O)* |
| 1 | 0.435 | 262 | 306 | 44 | |
| 2 | 0.1 | 35 | 466 | 67 | 563 |
| 3 | | | 317 | 46 | 1081 |
| 4 | 0.365 | 245 | 292 | 42 | >290 |
| 5 | 0.133 | 20 | 354 | 51 | 169 |

*Water resistance measurements were taken without the use of a supporting grid or mesh being used as part of the test.

The present invention may be embodied in other forms without departing from the spirit and the essential attributes thereof, and, accordingly, reference should be made to the appended claims, rather than to the foregoing specification, as indicating the scope of the invention. Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that may be performed it is understood that each of these additional steps may be performed with any specific embodiment or combination of embodiments of the disclosed methods.

The foregoing written description of structures and methods has been presented for purposes of illustration only. Examples are used to disclose exemplary embodiments, including the best mode, and also to enable any person skilled in the art to practice the invention, including making and using any devices or systems and performing any incorporated methods. These examples are not intended to be exhaustive or to limit the invention to the precise steps and/or forms disclosed, and many modifications and variations are possible in light of the above teaching. Features described herein may be combined in any combination. Steps of a method described herein may be performed in any sequence that is physically possible. The patentable scope of the invention is defined by the appended claims, and may include other examples that occur to those skilled in the art. Such other examples are intended to be within the scope of the claims if they have structural elements that do not differ from the literal language of the claims, or if they include equivalent structural elements with insubstantial differences from the literal language of the claim

The compositions and methods of the appended claims are not limited in scope by the specific compositions and methods described herein, which are intended as illustrations of a few aspects of the claims. Any compositions and methods that are functionally equivalent are intended to fall within the scope of the claims. Various modifications of the compositions and methods in addition to those shown and described herein are intended to fall within the scope of the appended claims. Further, while only certain representative compositions and method steps disclosed herein are specifically described, other combinations of the compositions and method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

As used in the specification and the appended claims, the singular forms “a,” “an,” and “the” include plural referents unless the context clearly dictates otherwise. Ranges may be expressed herein as from “about” or “approximately” one particular value, and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers, or steps. The terms “consisting essentially of” and “consisting of” may be used in place of “comprising” and “including” to provide for more specific embodiments of the invention and are also disclosed. “Exemplary” or “for example” means “an example of” and is not intended to convey an indication of a preferred or ideal embodiment. Similarly, “such as” is not used in a restrictive sense, but for explanatory or exemplary purposes.

Other than where noted, all numbers expressing geometries, dimensions, and so forth used in the specification and claims are to be understood at the very least, and not as an attempt to limit the application of the doctrine of equivalents to the scope of the claims, to be construed in light of the number of significant digits and ordinary rounding approaches.

Unless defined otherwise, all technical and scientific terms used herein have the same meanings as commonly understood by one of skill in the art to which the disclosed invention belongs. Publications cited herein and the materials for which they are cited are specifically incorporated by reference.

Additionally, the invention illustratively disclosed herein suitably may be practiced in the absence of any element which is not specifically disclosed herein.

1. A building material, comprising:
a porous membrane that comprises a thermoplastic polymer, at least one filler, and at least one extractable or removable processing oil, plasticizer, or solvent, wherein the microporous membrane has a water penetration resistance greater than 400 cm, greater than 500 cm, or greater than 600 cm when measured according to AATCC-127.

2. (canceled)

3. (canceled)

4. The building material of claim 1, further comprising a reinforcing layer on at least one side of the porous membrane to form a reinforced porous membrane.

5. The building material of claim 4, wherein the reinforcing layer is at least one of a woven material and a non-woven material.

6. (canceled)

7. (canceled)

8. The building material of claim 4, wherein the reinforced porous membrane has a water penetration resistance greater than 700 cm or greater than 800 cm when measured according to AATCC-127.

9. (canceled)

10. The building material of claim 8, wherein the reinforced porous membrane has a water penetration resistance greater than 900 cm or greater than 1,000 cm.

11. (canceled)

12. The building material of claim 1, wherein the porous membrane is hydrophobic.

13. The building material of claim 4, wherein the reinforced porous membrane is hydrophobic.

14. The building material of claim 5, wherein the reinforced porous membrane is hydrophobic.

15. (canceled)

16. The building material of claim 1, wherein the porous membrane is microporous.

17. The building material of claim 4, wherein the reinforced porous membrane has a drainage efficiency when measured according to ASTM E2273 that is 80% or greater.

18. The building material of claim 17, wherein the drainage efficiency is 85% or greater, or 90% or greater.

19. (canceled)

20. (canceled)

21. The building material of claim 1, wherein the porous membrane exhibits a water vapor permeance value from about 5 to about 80 perms, from about 20 to about 80 perms, or from about 50 to about 80 perms when measured according to ASTM E96 Method B.

22. (canceled)

23. (canceled)

24. The building material of claim 4, wherein the reinforced porous membrane exhibits a water vapor permeance value from about 5 to about 80 perms, from about 20 to about 80 perms, or from about 50 to about 80 perms when measured according to ASTM E96 Method B.

25. (canceled)

26. (canceled)

27. The building material of claim 1, further comprising a continuous or non-continuous adhesive layer on at least one surface of the porous membrane, wherein the porous membrane with the adhesive layer thereon exhibits a water vapor permeance value from about 5 to about 80 perms, from about 20 to about 80 perms, or from about 50 to about 80 perms when measured according to ASTM E96 Method B.

28. (canceled)

29. (canceled)

30. The building material of claim 1, wherein the thermoplastic polymer is a polyolefin.

31. The building material of claim 4, wherein the thermoplastic polymer is a polyolefin.

32. The building material of claim 31, wherein the woven or non-woven material is a polyolefin.

33. The building material of claim 30, further comprising a mesh on at least one side of the porous membrane, wherein the mesh is attached to the porous membrane with or without adhesive.

34. The building material of claim 33, wherein the mesh is attached without adhesive, and the mesh is optionally a polyolefin mesh.

35. (canceled)

36. The building material of claim 33, wherein the mesh is attached with an adhesive, and the mesh is optionally a polyolefin mesh.

37. The building material of claim 4, further comprising a mesh on a side of the porous membrane opposite to the reinforcing layer, on top of the reinforcing layer, or both on a side of the porous membrane opposite to the reinforcing layer and on top of the reinforcing layer, wherein the mesh is attached to the porous membrane, the reinforcing layer, or both the porous membrane and the reinforcing layer with an adhesive.

38. The building material of claim 31, further comprising a mesh on a side of the porous membrane opposite to the reinforcing layer, on top of the reinforcing layer, or both on a side of the porous membrane opposite to the reinforcing layer and on top of the reinforcing layer, wherein the mesh is attached to the porous membrane, the reinforcing layer, or both the porous membrane and the reinforcing layer without an adhesive.
